(19) United States
(12) Patent Application Publication
(10) Pub. No.: US 2014/0298430 A1
(43) Pub. Date: Oct. 2, 2014

(54) ELECTRONIC COMBINATION LOCK USING FIELDS WITH POSITION INDICATORS

(71) Applicant: LAUNCHKEY, INC., Las Vegas, NV (US)

(72) Inventors: Kristin F. Tomasik, Las Vegas, NV (US); Geoffrey R. Sanders, Las Vegas, NV (US); Jonathan C. Holske, Las Vegas, NV (US); Devin M. Egan, Las Vegas, NV (US)

(73) Assignee: LAUNCHKEY, INC., Las Vegas, NV (US)

(21) Appl. No.: 14/226,308

(22) Filed: Mar. 26, 2014

Related U.S. Application Data
(60) Provisional application No. 61/807,108, filed on Apr. 1, 2013.

(51) Int. Cl. G06F 21/31; G06F 21/60

(52) U.S. Cl. CPC G06F 21/31; G06F 21/60
USPC 726/5

(57) ABSTRACT

Systems and methods are provided for authenticating users using an electronic combination lock. More specifically, systems and methods are provided for authenticating users using an electronic combination lock by setting a passcode by manipulating a field including selecting multiple indicators in the field in a particular sequence and requiring an accessing user at a later time to repeat the sequence.

### CROSS-REFERENCE TO RELATED APPLICATIONS

The present application claims priority to U.S. Provisional Application No. 61/807,108 filed Apr. 1, 2013 which is hereby incorporated by reference in its entirety.

### FIELD

The subject matter described herein relates generally to identity authentication and safeguarding in computer networks and more particularly to systems and methods of authenticating a user using an electronic combination lock including fields with position indicators.

### BACKGROUND

User authentication is the process of confirming attributes or identities of users or devices. User authentication frequently requires use of user authentication signatures to identify a user. The ubiquity of devices in modern life requires the use of numerous user authentication signatures on a day-to-day basis for a single individual and the individual may use identical authentication signatures for each device or system.

Many modem devices use digital touch screens to allow users to interact with a device. Touch screen interaction frequently requires user authentication in order to prevent unauthorized access to the device. Personal identification number locks “PIN locks” have become standard practice on many touch screen devices, PIN locks may sometimes be alphanumeric combinations and require input of four or more letters or numbers before access to the device is granted. Typically PIN locks employ standardized placement of numbers or letters within PIN lock interfaces. Standardized placement generally means that there are actual buttons or virtual displays of buttons on the touch screen interface that always appear in the same screen location. These PIN locks suffer a variety of vulnerabilities such as the tendency for individuals to choose number combinations with personal numerical significance such as birthdays, anniversaries, zip codes, or words with personal significance. Additionally, PIN locks may sometimes be inadvertently revealed by users when tricked by social engineering techniques, phishing, or hacking. Furthermore, the natural oils from a user's fingertip may be deposited on a screen and assist unauthorized users in deciphering PIN locks based on the standardized placement of numbers within PIN lock interfaces. As PIN locks may be the sole factor in a user authentication process, once an unauthorized user has access this single PIN lock combination be may have virtually unrestricted access to private, confidential, or otherwise sensitive information.

Accordingly, systems and methods that provide user authentication using an electronic combination lock which includes manipulation fields instead of or in addition to standardized button placement may remedy these problems.

### SUMMARY

Provided herein are embodiments of methods and systems of user authentication using an electronic combination lock which includes manipulation fields with positional indicators.

In an embodiment, a method is provided using an electronic combination lock with one or more fields common to multiple position indicators such that a user may enter codes without removing a code input implement such as a finger or stylus from a touch screen. The use of fields rather than standardized alphanumeric buttons may help reduce unauthorized access by mental deduction means such as guessing or determining alphanumeric combinations as well as physical means such as identifying or measuring natural finger oils on buttons so as to physically deduce combinations.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A is an example diagram of a network connected authentication system according to an embodiment of the present invention;

FIG. 1B is an example diagram of a network connected authentication server system according to an embodiment of the present invention;

FIG. 1C is an example diagram of a user device according to an embodiment of the present invention;

FIG. 2 is a diagram depicting an example embodiment of a combination lock screen display with fields and indicators in accordance with the present invention.

FIG. 3 is a diagram depicting an example embodiment of an activation sequence of a locking mechanism in accordance with the present invention.

FIG. 4 is a diagram depicting an example embodiment of how a combination lock may be used in accordance with the present invention.

FIG. 5 is an example embodiment of a user interface in accordance with the present invention.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

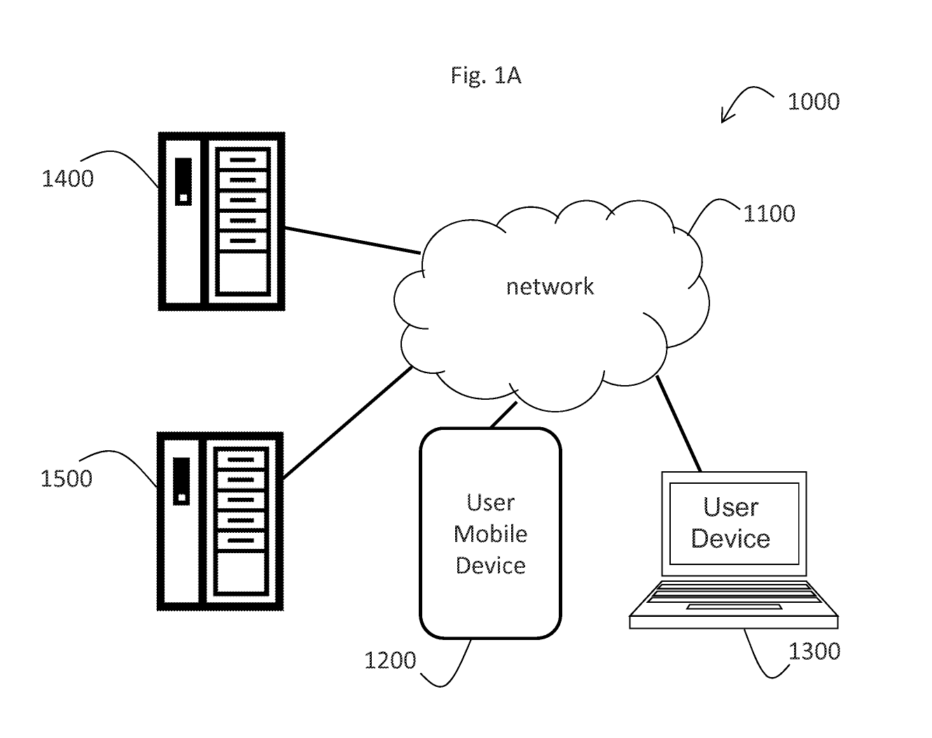

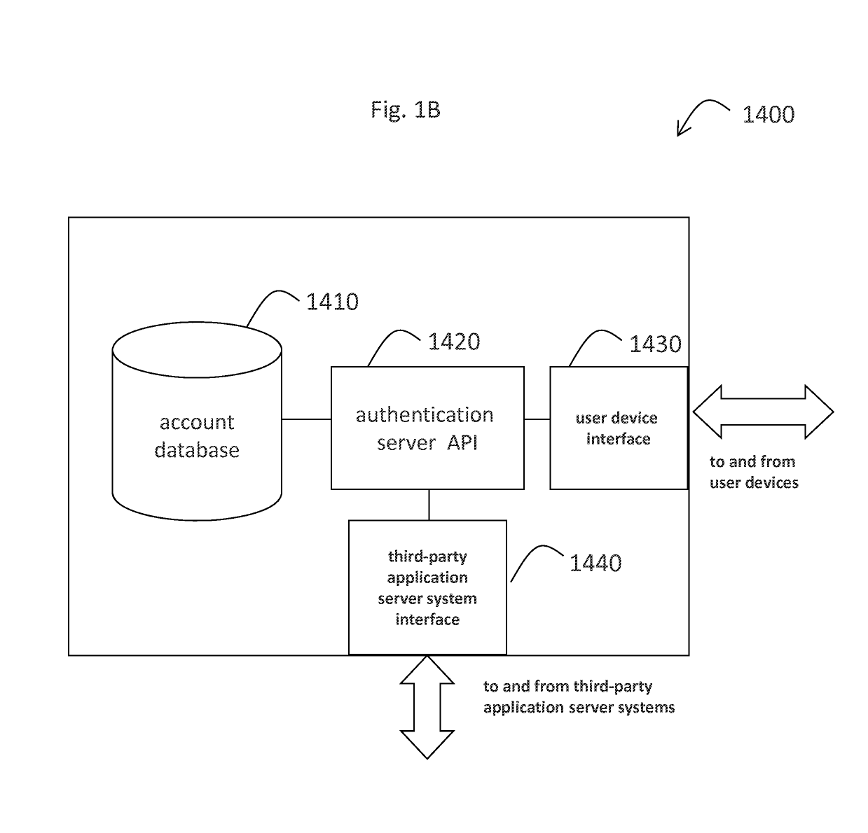

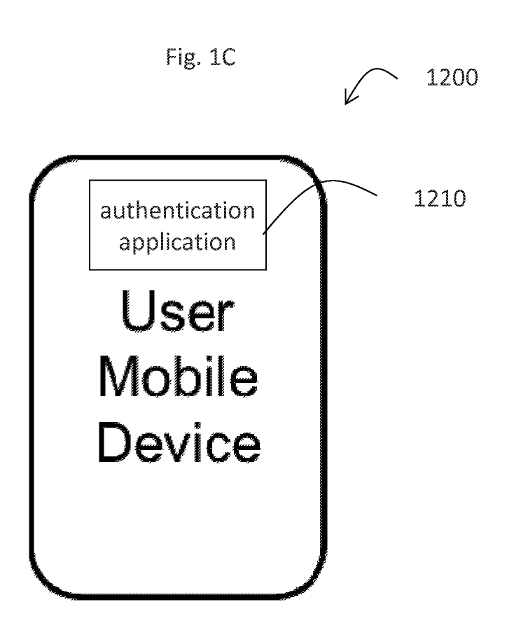

Turning to FIG. 1A, an example diagram of a network connected authentication system according to an embodiment of the present invention is shown.

In FIG. 1A, a system 1000 generally includes an authentication server system 1400 and a third-party application server system 1500, both of which may be distributed on one or more physical servers, each having one or more processors, memory, an operating system, input/output interfaces, and one or more network interfaces all known in the art, and a plurality of end user devices 1200, 1300 coupled to a network 1100, such as a public network (e.g., the Internet and/or a cellular-based wireless network) or a private network. User devices include, for example, mobile device 1200 (e.g., phone, tablet, etc.), desktop or laptop device 1300, wearable devices (e.g., watch, bracelet, glasses, etc.), other devices with computing capability and network interfaces, and so on. The third-party application server system 1500 includes, for example, a system that provides web site transactions, the capability to start or stop a vehicle, the capability to approve settings on a video game console, the capability to open or lock a door, other systems that require remote approval authorization, local applications such as games, and others.

Turning to FIG. 1B, an example diagram of a network connected authentication server system according to an embodiment of the present invention is shown.

In FIG. 1B, a diagram of an authentication server system 1400 according to an embodiment is shown. Authentication server system 1400 includes a user device interface 1430 implemented with technology known in the art for communication with user devices 1200, 1300. Authentication server system 1400 also includes a third-party application server system interface 1440 implemented with technology known in the art for communication with third-party application server system (TPA) 1500. Authentication server system 1400 may further include an authentication server application program interface (API) 1420 that authenticates a user of the third-party application server system 1500 and user devices 1200, 1300. The authentication server API 1420 is coupled to a user account database 1410 to store user accounts as will be described below. Database 1410 may be implemented with technology known in the art, such as relational databases and/or object oriented databases.

Turning to FIG. 1C, an example diagram of a user device according to an embodiment of the present invention is shown.

In FIG. 1C, a diagram of a user mobile device 1200 according to an embodiment is shown. User mobile device 1200 includes a network connected authentication application 1210 that is installed in, pushed to, or downloaded to the user mobile device 1200. User mobile device 1200 in many embodiments is a touch screen device 102 as described below.

Generally, a network connected authentication application 1210 is installed in, pushed to, or downloaded to user mobile device 1200. The user of the application 1210 creates a user account with the authentication server system 1400 and pairs (associates) user mobile device 1200 with the user account. The user may also provide to authentication server system 1400 one or more email addresses or phone numbers for verification. In some embodiments a user may access TPA 1500, and TPA 1500 will send an authentication request to authentication server system 1400. Authentication server system 1400 looks up information in the user account and sends a request to at least one of the user mobile devices 1200 for the user to grant or deny access, e.g., by simply sliding or pushing a button. Authentication server system 1400 may then send a response to TPA 1500, which will grant or deny the access accordingly. In some embodiments, application 1210 may poll authentication server system 1400 to check the status of the authentication.

In some embodiments, system 1400 provides an online dashboard that a user, an application developer, or an administrator can access to create (or register) TPA 1500, and perform other functions.

Other aspects of network connected authentication are understood to be applicable here, some of which are discussed in U.S. patent application Ser. No. 13/961,651 by Egan which is herein incorporated by reference in its entirety.

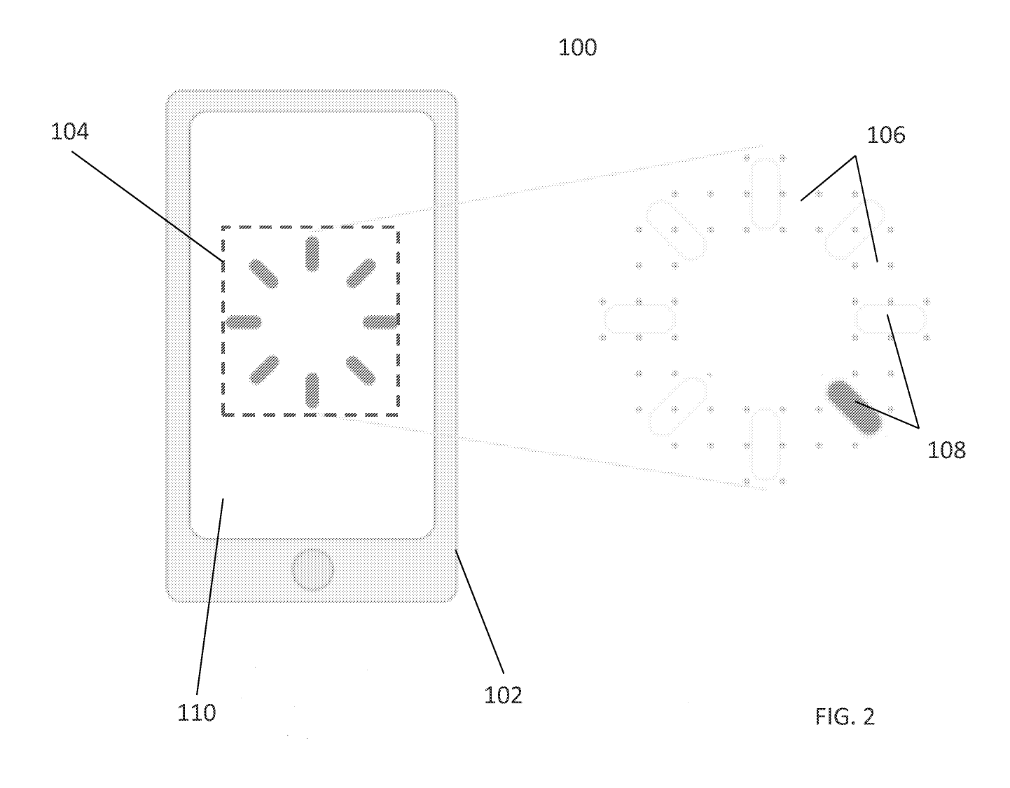

Turning to FIG. 2, a diagram depicting a combination lock screen with fields and indicators is shown in accordance with the present invention. FIG. 2 generally shows passcode authentication system 100 including a touch screen device 102 with touch screen 110, combination security lock interface 104, manipulation field 106, and indicator 108.

Passcode authentication system 100 may be authentication application 1210 in some embodiments. In some embodiments passcode authentication system 100 may control access to user mobile device 1200 (touch screen device 102 in many embodiments), device applications, third party applications, third party services, websites, or other programs, systems, data or other information.

Touch screen device 102 may be any touch screen device that a user can interact with using single or multi-point gestures on at least one touch screen 110. Touch screen 110s may be manipulated using special stylus, pen, or pointing tools; by using fingernails, knuckles, fingers, thumbs, or other anatomical parts either with or without gloves or coverings which may be specialized; or any number of other interaction tools. Typical characteristics of touch screen 110s include a display that doubles as an interaction register. This provides a simplicity and intuitiveness for users who simple touch the area of the display they wish to interact with rather than using a mouse or keyboard for movement and manipulation of onscreen objects. Touch screen devices may be included in gaming consoles, tablet computers, smartphones, personal digital assistants (PDAs), electronic books, and other devices.

Touch screen 110s may include one or more in number of past, present, and future technologies including but not limited to resistive, surface acoustic wave, surface capacitance, projected capacitance (in mutual or self-capacitance varieties), infrared grid, infrared acrylic, projection, optical imaging, dispersive signal, acoustic pulse recognition, or others.

Typically, touch screen 110s include a multi-layered construction with polyester layers, spacers, glass layers, or others and a monitoring system determines a user's intended command based on a location determination of where a user touched the touch screen 110 and what was being displayed on that portion of the touch screen at the point in time the user touched the touch screen.

While touch screen devices are discussed in the example embodiment, it should be understood that the technology described herein is broadly or universally applicable in numerous applications and devices including graphics tablets, graphics tablet-touch screen hybrids, touchpads, or others. Advantages of using the system and methods described below may be most helpful in touch screen or other devices described in this paragraph but some other advantages, such as use of indicators rather than PIN lock numbers, may have cross-platform applicability and provide advantages in other systems such as mouse point-and-click systems, traditional keyboard systems, vocal recognition systems, and others.

Combination security lock interface 104 in the example embodiment is a display with particular components including at least one manipulation field 106 (shown in the diagram as a dot matrix in a circular orientation) and multiple indicator 108s located in manipulation field 106. In the example embodiment shown, eight indicator 108s are located at regular intervals around manipulation field 106. Irregular spacing or intervals are contemplated in some embodiments.

Although manipulation field 106 in the example embodiment has a circular shape with a void at its center, other embodiments of the invention may include one or more manipulation field 106s in other orientations. Numerous regular and irregular polygonal shapes may be used in varied embodiments including normal circles, ovals, squares, triangles, octagons, star shapes, diamonds, or others. Additionally, although combination security lock interface 104 depicts a two-dimensional figure in the example embodiments, manipulation field 106 may be more complex in some embodiments such as having three-dimensional shapes that may rotate or otherwise allow for manipulation by turning, flipping, or otherwise moving, clicking, or interacting with the shapes. Timing-related embodiments also exist which may include movement, changing, or other dynamism of the shape of manipulation field 106 that is depicted as a static two-dimensional figure in the example embodiments. In some embodiments manipulation field may cease to exist for periods of time and reappear such that a user would be required to cease touching or otherwise manipulating touch screen 110 of touch screen device 102 for certain periods of time or particular locations on touch screen 110. In some embodiments the location of manipulation field 106s on touch screen 110 may change on successive uses of combination security lock interface.

In the example embodiment indicator 108′s are simple rounded bar shapes. In some embodiments indicator 108s may take a variety of other forms. These may include objects, shapes, figures, pictures from device memory, preset pictures, images, numbers, numerals, letters, characters, hieroglyphs, glyphs, pictographs, signs, or others. In some embodiments indicator 108s may be homogeneous. In some embodiments indicator 108s may be partially homogeneous, such that some groups of indicator 108s may be homogeneous. In some embodiments indicator 108s may be heterogeneous. In some embodiments indicator 108s may be static while in other embodiments indicator 108s may be dynamic. Dynamic indicator 108s may be restricted to movement within manipulation field 106s or may travel in and/or out of manipulation field 106s. In some embodiments false, fake, or red herring indicator 108s may mimic or otherwise trick unauthentic users by providing inactive locations outside of manipulation field 106s on touch screen 110s, unbeknownst to unauthentic users. Dynamic indicator 108s may also change size, shape, color, font, display or otherwise in some embodiments.

In the example embodiment, indicator 108′s may change color, light up, show halos, or otherwise indicate that a user is currently touching or selecting (or has recently touched, selected, or passed over) one or multiple indicator 108′s when touch screen device 102 senses that a user is manipulating a portion of manipulation field 106 on touch screen 110. In some embodiments manipulation field 106 is invisible while in other embodiments manipulation field 106 may be partially or wholly demarcated.

In a typical embodiment of the invention, a user will manipulate touch screen 110 by touching manipulation field 106 with a finger and the finger will remain in contact with touch screen 110 while the user moves through a predetermined combination. As will be described below, a user chooses or sets the combination including positions in manipulation field 106. Since the user does not pick up the finger from touch screen 110 and manipulation field 106 is a circular path in the example embodiment, the finger may retrace particular points or portions of manipulation field 106 while inputting a combination. This property reduces the chance that natural oils from the finger could be used as a means to infer the combination because they are not left in standardized locations on the touch screen but rather are dragged through manipulation field 106. In other words, natural oils from the finger would be left in a common field on touch screen 110 in manipulation field 106 and not in different, distinct locations as in traditional PIN lock systems where a user touches distinct locations of display buttons on touch screen 110 without tracing over a common field because the user's finger is removed from touch screen 110 after inputting each individual part of the combination.

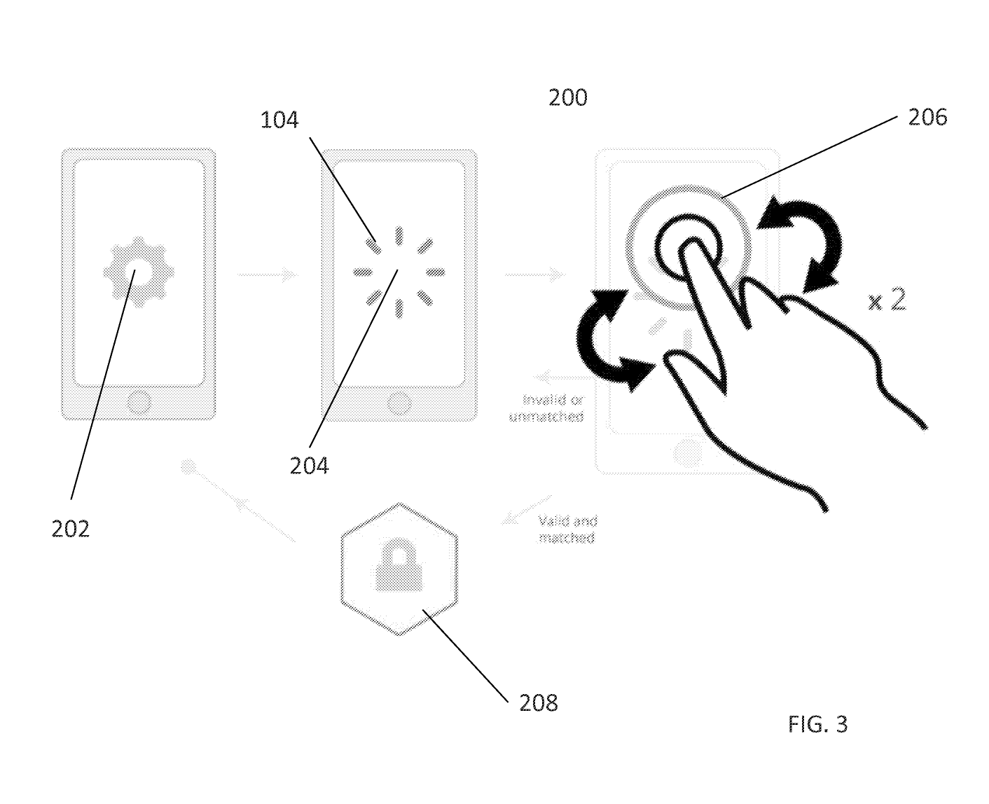

Turning to FIG. 3, an example diagram depicting an activation sequence 200 is shown. FIG. 3 generally shows a four step activation sequence embodiment including initialization step 202, lock interface display step 204, authentication pattern creation step 206, and pattern setting step 208.

In the example embodiment, a user starts by downloading, installing, or accessing a security lock interface program. In some embodiments the user may input identifying information such as email addresses and passwords to register an account and pair a device. The user then begins activation sequence 200 by going to initialization step 202. This step may include on screen instructions on how the process works. In some embodiments initialization step 202 may include choosing particular applications, programs, or other software which will apply the security lock interface program. After this has been completed the user is shown lock interface display step 204.

In some embodiments lock interface display step 204 may include choosing what type of lock interface display will be used from a list of options with varied configurations or other specifications. In some embodiments lock interface display step 204 may merely show a preprogrammed lock interface display such as manipulation field 106 shown in the example embodiment. Next the user is tasked with creating a validation pattern in validation pattern creation step 206.

In authentication pattern creation step 206 a user creates a unique combination by touching touch screen 110 in manipulation field 106. In an example embodiment, the user then manipulates touch screen 110 by dragging a finger around manipulation field 106 and stopping or otherwise selecting indicator 108′s in a particular sequence (indicated by two-headed arrows in the diagram).

In an example embodiment of pattern creation step 206, referring back to FIG. 2, a user will create a first authentication pattern by selecting key indicators in manipulation field 106. Selecting key indicators in manipulation field 106 may start by touching a finger to the indicator 108 top position of manipulation field 106 (the location of North if manipulation field 106 is thought of as a compass with directions and North is located at the top of manipulation field 106). From this location, without lifting the finger, the user may drag in a clockwise fashion through manipulation field 106 to the third indicator position (SouthEast on a compass) before stopping, at which point the third indicator position would turn blue to indicate it was selected as a key indicator. Indicator 108′s may change to intermediate colors or otherwise alter their appearance as manipulation field 106 near them is touched. This means that as the user drags a finger over the touchscreen from North to Southeast through manipulation field 106 that Northeast and East positions may turn yellow for instance before changing back to a neutral color after they are passed over.

In the example embodiment changing direction in manipulation field 106 near or at an indicator 108 will cause the closest indicator 108 to be selected as a key indicator in the first authentication pattern. The user then drags the finger counterclockwise to another indicator 108 to select another key indicator. This process continues until the user decides the authentication pattern is complete. In the example embodiment the system checks that at least two indicator 108 positions have been selected as key indicators before the user has removed the finger from touch screen 110 otherwise the system may prompt the user that the pattern was invalid and the process may restart. Typically no upper boundary is set, such that a user may include as many key indicators as desired (or as many as can be comfortably or possibly remembered and correctly input at later times). In some embodiments merely hesitating over a position for a preselected period of time (for instance a half second, whole second, or others) may cause the indicator 108 to be selected as a key indicator. Haptic technology or other tactile feedback may be used in some embodiments of the invention to indicate to a user when a particular indicator 108 has been selected as a key indicator or to indicate user interaction with the touch screen during particular interactions.

In some embodiments a user may remove a finger from the touchscreen at some points during the combination. In some embodiments the same position may be selected twice in a row if a full traversal of manipulation field 106 is made, if the user removes the finger from the touch screen 110 and replaces it in the same location, or in other ways.

When the user has finished creating a first authentication pattern he may select a “finished” button or the system may use cues such as a timeout function or finger removal from touch screen 110 in order to determine that the first authentication pattern is complete. The first authentication pattern is then one-way hashed. The system may next prompt the user to enter a second authentication pattern in an identical manner to the first authentication pattern, essentially to reenter the first authentication pattern. This step ensures that the user intended the authentication pattern registered by the system using touch screen 110 and helps ensure the user remembers the first authentication pattern. Upon entering the second authentication pattern, it is one-way hashed. The one-way hashes for each of the first authentication pattern and the second authentication pattern are then compared to determine if they are identical. If the second authentication pattern is determined to be identical to the first authentication pattern after the comparison then the one-way hash for the first authentication pattern is stored. In some embodiments the one-way hash may be stored locally. In some embodiments the one-way hash may be stored remotely. The stored one-way hash may then be used as a reference one-way hash of first authentication pattern for comparisons of future authentication pattern attempts. If the user entered a different second authentication pattern from the first authentication pattern, the program may inform the user that the first and second authentication patterns do not match and the user may be prompted to restart by entering a new first authentication pattern. If the second authentication pattern matches the first authentication pattern then the combination security lock will be activated in pattern setting step 208. In some embodiments, after this point, if the user wishes to change the authentication pattern then the user may access the settings again and begin activation sequence 200 anew.

In many embodiments if a user has already been through an activation sequence and set a first authentication pattern, any attempt to change the first authentication pattern or otherwise create or apply a second authentication pattern will require user authentication using the first authentication pattern. User authentication using the first authentication pattern requires correctly inputting the first authentication pattern to confirm the user is authentic before a change to a second authentication pattern is allowed by the system. This user authentication requirement reduces the chance that unauthenticated users who may have gained access to sensitive or private files, programs, or devices will be able to successfully change authentication patterns to lock out the original user who set the first authentication pattern.

Although one-way hashing is used in the example embodiment above, other means of comparing first and second authentication patterns may be used in other embodiments. In some embodiments this may include storing the patterns unaltered or encrypted in local memory or elsewhere before comparing them.

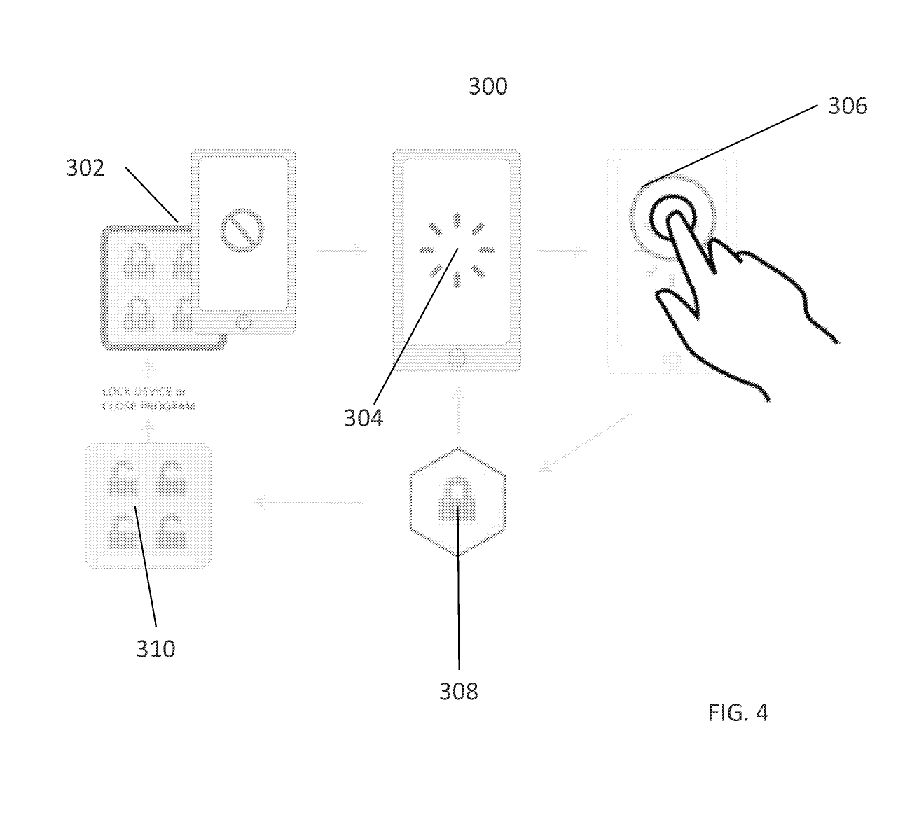

Turning to FIG. 4, a combination lock use case 300 is shown. FIG. 4 generally shows a five step combination lock use embodiment including an accessing step 302, a security lock display step 304, an authentication pattern input step 306, a combination comparison step 308, and an unlocking step 310.

Prior to accessing step 302, a user has completed activation sequence 200 described above and a first authentication pattern has been stored. In various embodiments contemplated herein, a user first turns on a display or wakes up the device or otherwise attempts to access a program or file protected with a stored first authentication pattern in accessing step 302. The system causes the device to display combination security lock interface 104 in security lock display step 304. The user may in some embodiments be prompted by the program to input an attempted authentication pattern or the user may otherwise recognize the need to input the attempted authentication pattern in authentication pattern input step 306. The user then inputs an attempted authentication pattern by interacting with manipulation field 106 as described above. The attempted authentication pattern is one-way hashed (similar to the first authentication pattern previously and using the same algorithm) and the one-way hash for the attempted authentication pattern is compared to the one-way hash for the first authentication pattern in combination comparison step 308. If the attempted authentication pattern does not match the first authentication pattern then the program may loop back to security lock display step 304. If the attempted authentication pattern does match the first authentication pattern then the system will grant access and unlock the protected file, program, or device. Upon locking the device or closing or otherwise leaving the program, combination lock use case 300 will begin again at accessing step 302.

In some embodiments a maximum number of consecutive tries threshold may have been previously set by a user or administrator or otherwise exist, whereby when a user attempting to access the protected file, program, or device meets or exceeds the maximum number of consecutive tries threshold and the device locks or otherwise restricts access. In some embodiments when the maximum number of consecutive tries threshold is met or exceeded the system may remain locked for a specific time as a cool-off period. Examples include thirty seconds, five minutes, eighteen hours, three days, two weeks, or any other amount of time that may be chosen by a user or set by an administrator. This cool-off period is meant to prevent brute force attacks by hackers or other individuals attempting to gain access to the protected program, file, or device. In other embodiments, more extreme security measures may be taken when the maximum number of consecutive tries threshold is met or exceeded. One such measure may be a complete system lockdown and/or access removal. Other measures may include the system destroying, eliminating, or otherwise deleting the protected program or file or wiping the memory of a device.

In the example embodiment here, a maximum number of consecutive tries threshold is set at ten unsuccessful attempts. In the example embodiment a typical penalty for users exceeding the ten unsuccessful attempt threshold is an un-pairing the device from the system. As a result, the user may be required to go through the process originally used to register the device before being granted access again. As an alternative or supplement, an administrator may be able to grant access again.

In some embodiments multiple levels or stages of authentication may exist. This means that once one level or pattern is authenticated, additional or successive authentication patterns may be required to be matched in order to unlock the device.

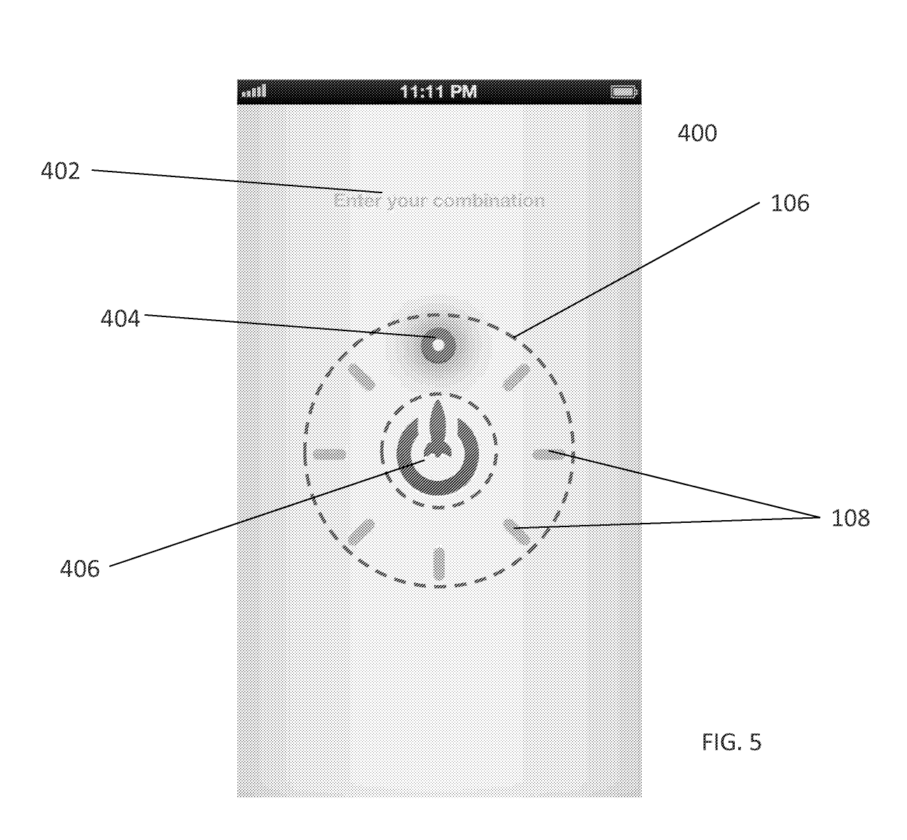

Turning to FIG. 5, an example embodiment of a user interface 400 in accordance with the present invention is shown.

FIG. 5 generally shows user interface 400 including informational field 402, manipulation field 106, indicator 108, selected indicator 404, and button 406.

In the example embodiment manipulation field 106 is invisible to a user but demarcated for illustration's sake by dashed circles. Selected indicator 404 shows how an indicator 108 may indicate to a user that it is currently selected. Informational field 402 shows instructions in the example embodiment but may include additional, less, or varied information in other embodiments. Button 406 may have various uses in various embodiments including but not limited to showing settings, providing activation, confirmation, or others. Not pictured are other possible elements provided in user interface 400 including a back or exit button among others.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A non-transitory computer readable medium including instructions that are configured to cause a computer system to protect data on a device using a passcode by performing a method comprising:
1) setting the passcode by monitoring user manipulation of a field including registering selection of two or more indicators in a sequence within the field and storing the sequence; and
2) allowing subsequent user access to the protected data on the device only after the subsequent user replicates manipulation of the field including selecting the same two or more indicators in the same sequence within the field by comparing the replicated manipulation of the field with the stored sequence.

2. The non-transitory computer readable medium including instructions that are configured to cause a computer system to protect data on a device using a passcode by performing the method according to claim 1, wherein manipulating a field to select two or more indicators in a sequence within the field further comprises:
monitoring to ensure the user maintains contact with the field during the selecting two or more indicators, otherwise notifying the user of an invalid input.

3. The non-transitory computer readable medium including instructions that are configured to cause a computer system to protect data on a device using a passcode by performing the method according to claim 1, wherein the field is invisible to users.

4. The non-transitory computer readable medium including instructions that are configured to cause a computer system to protect data on a device using a passcode by performing the method according to claim 1, further comprising:
determining whether manipulation of the field to select the same two or more indicators in the same sequence occurred in the subsequent attempt and if not, granting the user another attempt unless a maximum attempt number threshold has been reached, at which point further attempts are blocked for a period of time.

5. A system of user authentication on a device comprising:
protecting data on the device using a passcode combination wherein the passcode combination is set by an administrator, wherein setting the passcode combination includes dynamic manipulation of a field including selecting indicators.

6. The system of user authentication on a device of claim 5, wherein setting the passcode combination further comprises:
monitoring the dynamic manipulation of the field to ensure the user maintains contact with the field while selecting two or more indicators, otherwise notifying the user of an invalid input.

7. The system of user authentication on a device of claim 5, wherein the field is invisible to users of the device but indicators are shown.

8. The system of user authentication on a device of claim 5, further comprising:
determining whether the user selects the same two or more indicators in the same sequence in a subsequent attempt and if not, granting the user another attempt unless a maximum attempt number threshold has been reached, at which point further attempts are blocked for a period of time.

9. A system of user authentication on a device comprising:
on a wireless device capable of communication with an authentication server, pairing a user account of an authentication application on the wireless device with the authentication server by communicating over a communication network;
setting a first authentication code on the device to protect data on the device by choosing a sequence of key indicators within a field from numerous indicators within the field;
requiring a user to input a replication of the first authentication code on the device in order to access the protected data on the device by selecting key indicators within the field from numerous indicators within the field in the same sequence of key indicators as set in the first authentication code; and
unpairing the user account of the authentication application on the wireless device from the authentication server by suspending the user account if the user fails to input the replication of the first authentication code on the device after a number of attempts.

10. The system of user authentication on a device according to claim 9, wherein setting a first authentication code on the device to protect data on the device by choosing a sequence of key indicators within a field from numerous indicators within the field further comprises:
requiring a user to confirm the chosen sequence of key indicators by inputting a replication by selecting key indicators within the field from numerous indicators within the field in the same sequence twice before setting the first authentication code.

11. The system of user authentication on a device according to claim 10, wherein if the same sequence is not entered twice consecutively, requiring the user to choose a sequence of key indicators within a field from numerous indicators within the field again.

12. The system of user authentication on a device according to claim 9, wherein a suspended user account is revived by the wireless device communicating with the authentication server over a communication network, wherein the communicating includes confirming a user identity using personal information.

13. The system of user authentication on a device according to claim 9, wherein setting a first authentication code on the device further comprises:
one-way hashing the first authentication code.

14. The system of user authentication on a device according to claim 9, wherein after a first authentication code is set on the device to protect data on the device a lock screen appears in place of the data upon each subsequent attempt to access the data.

15. The system of user authentication on a device according to claim 9, wherein the first authentication code on the device to protect data on the device may be reset.

16. The system of user authentication on a device according to claim 15, wherein resetting the first authentication code further comprises:
requiring a user to input a replication of the first authentication code by selecting key indicators within the field from numerous indicators within the field in the same sequence before allowing the user to input a new first authentication code.
